(19) United States
(12) Patent Application Publication
(10) Pub. No.: US 2005/0021639 A1
(43) Pub. Date: Jan. 27, 2005

(54) Actionable messaging

(75) Inventors: Calvin Wang, Millbrae, CA (US); Zhou Ye, Fremont, CA (US); Jimmy Shi, Santa Clara, CA (US); Ali Shah, Solna (SE); Okan Alper, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Oracle International Corporation, Redwood City, CA (US)

(21) Appl. No.: 10/687,219

(22) Filed: Oct. 15, 2003

Related U.S. Application Data
(60) Provisional application No. 60/482,383, filed on Jun. 25, 2003.

(51) Int. Cl. G06F 15/16

(52) U.S. Cl. 709/206; 709/218

(57) ABSTRACT

Techniques for actionable messaging are provided. A message is sent to a device that outlines possible actions. Information for the message and action is stored and used when a response message is received. A user can then respond with a message specifying a desired action. The stored information is used to determine the action to perform and the action is performed.

### CROSS-REFERENCES TO RELATED APPLICATIONS

This application is a non-provisional application of and claims the benefit of U.S. Provisional Application No. 60/482,383, filed on Jun. 25, 2003, (Attorney Docket No.: 021756-0027010US), which is incorporated by reference in its entirety for all purposes.

### BACKGROUND OF THE INVENTION

The present invention generally relates to messaging and more specifically to techniques for providing messages that enable actions to be performed.

Message alerts are used by many entities as a notification tool. Messages may be sent in response to an event or as a source of information. For example, stock quotes may be sent when a stock reaches a certain price. Message alerts provide timely delivery of information at a lower cost than using other communication channels such as using customer service representatives to notify users of events. As more and more users adopt messaging devices that can receive message alerts, message alerts will become increasingly valuable.

The message alerts that are sent to devices are typically stand-alone messages. For example, the messages are only meant to be notifications and are not meant to be responded to. Thus, if a user desires to respond or perform any actions after viewing the message alert, the user typically switches communication channels to perform the desired action. For example, the user may receive the stock alert notification in a text message and then may use the Internet in order to buy or sell the stock.

Accordingly, methods and apparatus for enabling a user to respond to a message with desired actions are desired.

### BRIEF SUMMARY OF THE INVENTION

Embodiments of the present invention generally relate to actionable messaging. A message is sent to a device that outlines possible actions. Information for the message and action is stored and used when a response message is received. A user can then respond with a message specifying a desired action. The stored information is used to determine the action to perform and the action is performed.

In one embodiment, a method for messaging with devices in order to determine one or more actions to perform is provided. The method comprises: storing information for a message, the stored information comprising action information corresponding to the one or more actions; sending a message to a device including a message identifier and one or more action identifiers corresponding to the one or more actions; receiving a response message from the device, the response message including an action identifier in the one or more action identifiers and the message identifier; determining the stored information using the message identifier; determining action information for the action in the stored information using the action identifier; and performing the determined action using the action information.

In another embodiment, a method for messaging with devices in order to determine one or more actions to perform is provided. The method comprises: storing information on how to perform one or more actions; sending a message to a device including information identifying the one or more actions; receiving a text message from the device including information identifying a desired action in the one or more actions; determining stored information on how to perform the desired action using the information specifying the desired action; and causing the determined action to be performed using the information on how to perform the desired action.

In yet another embodiment, a device for generating and processing messages to determine actions to perform is provided. The device comprises: a message generator configured to generate a message identifying one or more actions and to send the generated message to a device; an information storer configured to store information associated with the identified one or more actions; a receiver configured to receive a response message from the device, wherein the response message identifies an action in the one or more actions identified in the message sent to the device; an action determiner configured to determine stored information for the identified action; and an action performer configured to cause the action to be performed using the determined stored information.

In another embodiment, a system configured to perform actionable messaging is provided. The system comprises: one or more devices; an application configured to perform actions; and an actionable message device configured to communication with the one or more devices and the application, the device comprising: a message generator configured to generate a message identifying one or more actions and to send the generated message to a device; an information storer configured to store information associated with the identified one or more actions; a receiver configured to receive a response message from the device, wherein the response message identifies an action in the one or more actions identified in the message sent to the device; an action determiner configured to determine stored information for the identified action; and an action performer configured to cause the action to be performed using the determined stored information.

A further understanding of the nature and advantages of the invention herein may be realized by reference of the remaining portions in the specifications and the attached drawings.

### BRIEF DESCRIPTION OF THE DRAWINGS

FIG. 1 illustrates a system for providing actionable messages according to one embodiment of the present invention.

FIG. 2 illustrates a simplified flowchart of a method for providing an actionable message according to one embodiment of the present invention.

FIG. 3 illustrates a system for providing actionable messages according to one embodiment of the present invention.

FIG. 4 illustrates an example of information included in stored information, an actionable message, a response message, and an action command.

### DETAILED DESCRIPTION OF THE INVENTION

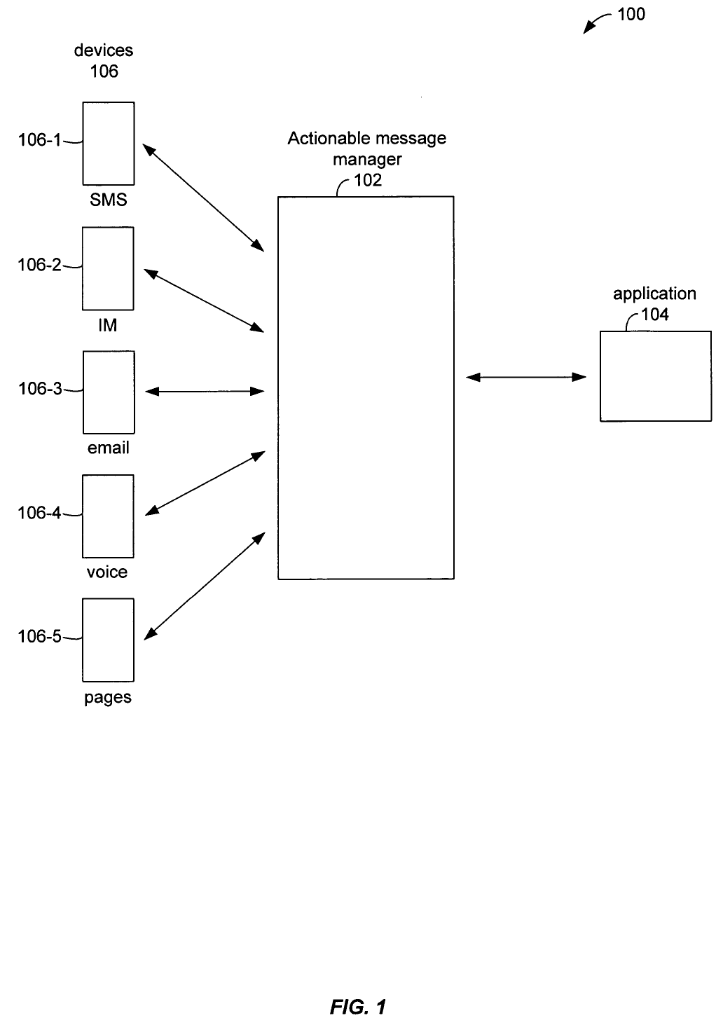

FIG. 1 illustrates a system 100 for providing actionable messages according to one embodiment of the present invention. System 100 includes an actionable message manager (AMM) 102, and application 104, and one or more devices 106. Entities in system 100 communicate through a network, such as the Internet, a local area network (LAN), a wide area network (WAN), a wireless network, an intranet, a private network, a public network, a switched network, or any other suitable communication network.

Devices 106 include any devices that can receive messages, such as a short message service device 106-1, an instant message (IM) device 106-2, an e-mail device 106-3, a voice device 106-4, a pager device 106-5, etc. In one embodiment, a device 106 comprises a communication type and an address for a user. For example, an e-mail device may be a computing device that is enabled to receive e-mail for an e-mail address associated with a user. While a user may use any computing device to access e-mail, it will be recognized that any computing device with e-mail access may be device 106-3.

Devices 106 include different communication capabilities. For example, SMS device 106-1 is configured to receive text messages only in one embodiment. Also, IM device 106-2 is configured to receive instant messages and may receive a URL in the instant message. Different device 106 communicates using different communication channels and protocols. AMM 102 is configured to determine the correct channels and protocols needed to communicate with each device 106.

Application 104 may be any application that can perform actions. For example, application 104 may be a web-based application that receives instructions for actions from actionable message manager 102. Application 104 may receive a uniform resource locater (URL) from AMM 102 that invokes a web application and indicates an action to perform. Application 104 may also be software code configured to perform actions based on instructions from AMM 102.

Actionable message manager 102 is configured to communicate with devices 106 and application 104. AMM 102 generates messages that are compatible in format with any of devices 106. For example, AMM 102 may send an instant message to IM device 106-2, an e-mail to device 106-3, a voice message device 106-4, etc. AMM 102 generates actionable messages in that a message sent to a device 106 can be replied to with a desired action. AMM 102 stores information for the sent actionable message that enables AMM 102 to determine a desired action when a response message is received from device 106. When the action is determined, AMM 102 communicates with application 104 to perform the action. The results of the action may then be sent to the device 106 that sent the message or any other device 106.

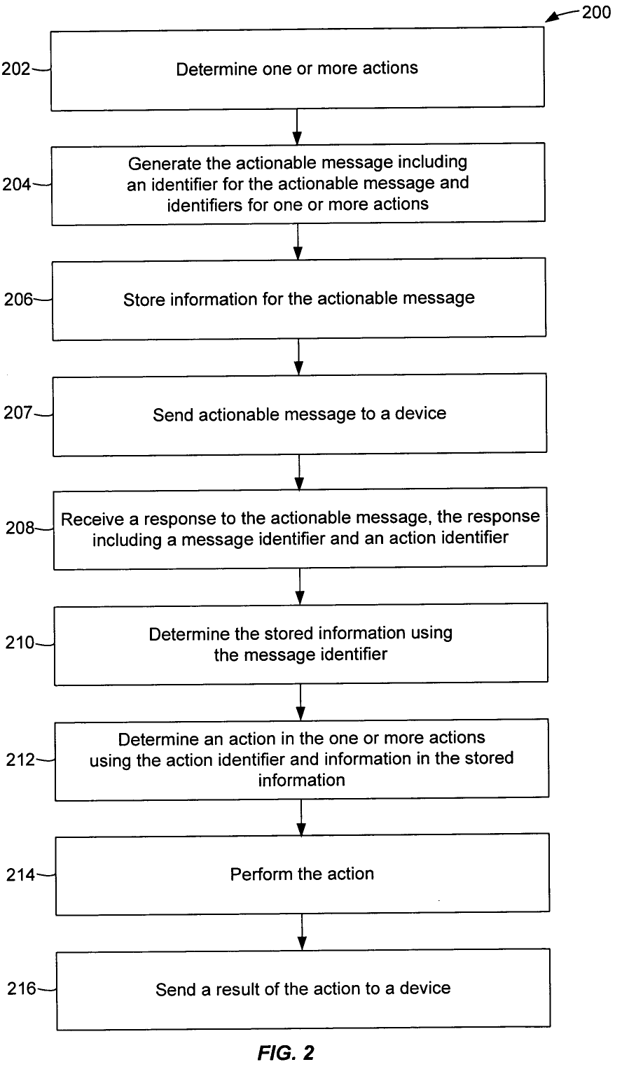

FIG. 2 illustrates a simplified flowchart 200 of a method for providing an actionable message according to one embodiment of the present invention. In step 202, one or more actions are determined. The actions may be any actions that can be performed using application 104. Examples of actions may be sending an e-mail, sending an instant message, performing a stock trade, retrieving a document, printing a document, or any other application-based action.

In step 204, an actionable message is generated. In one embodiment, the actionable message includes a message identifier for the actionable message and identifiers for the one or more actions. The message identifier may be included in a response message and is used to identify which sent actionable message the response is associated with. The message identifier is also used to retrieve the stored information as described below. Additionally, the identifiers for the one or more actions may be included in a response message and are used to determine actions to perform. Thus, if a user desires to perform an action in the one or more actions, the user may include the message identifier and identifiers for desired actions in a response message.

In step 206, information is stored for the actionable message. The information that is stored includes state information that is unique to the actionable message. For example, the actionable message is associated with a message identifier that may be used to retrieve the stored information when a response message for the actual message is received from a device 106. The message identifier may be any combination of characters that uniquely identifies the actionable message. Also, the message identifier may be associated with other information, such as unique user information (e.g., user's email address, phone number, or any return address). For example, when a response message is received, the stored information is retrieved using the message identifier and return address of the user that sent the message.

In addition to storing information that identifies the actionable message, information associated with one or more actions that may be performed is stored. For example, information that identifies which actions are associated with the actionable message is stored. If an actionable message is sent that allows a user to perform a first and second action, identifiers for the first and second actions are stored. If a first action is the action of sending the news for a stock and the second action is the action of sending a detailed quote, the numbers “1” and “2” may be associated with those actions in the stored information. The response to the actionable message may include the numbers “1” and/or “2” depending on which actions are desired. The numbers and stored information are then used to determine that the number “1” corresponds to the action of retrieving news about a stock and sending the retrieved news to a device and that the number “2” corresponds to retrieving a detailed quote and sending the retrieved detail quote to a device.

In one embodiment, the actionable message sent to device 106 includes a text message that identifies the action identifiers, actions, and/or message identifiers. The text message may also include content other than text, such as images, markup, etc. In one example, the text message may be a plain text format, a markup language, etc. In one embodiment, information that directly links back to information stored in AMM 102 is not included in the actionable message. For example, links with embedded information, such as URLs that are embedded in a web document, that, when selected, directly link back to information in AMM 102 are not sent with the actionable message. If direct links to the stored information are not included, AMM 102 is configured to determine stored information from information in the response message. Although it is described that a text message is sent without direct links back to information in AMM 102, it will be understood that a web-based message with URLs may also be sent as an actionable message. In this case, the message may link back to information that is used to determine the action desired.

When an actionable message is sent to device 106, if there are no direct links back to information stored in AMM 102 (e.g., URLs), the message, if responded to, may include the identifier for the actionable message. The identifier is then used to determine the stored information. In this case, the state of the sent actionable message may be retrieved when a response message is received. Additionally, the identifiers for the one or more actions, if invoked using the actionable message, may not be directly compatible with application 104. For example, the identifiers identify that a certain action should be performed. Information associated with the identifier in the stored information is used to determine which action to perform and how to perform the action. For example, AMM 102 may use the stored information to send an instruction to application 104 to perform an action. If a URL is associated with the action identifier in the stored information, AMM 102 make an HTTP request as specified by the URL to instruct application 104 to perform the action. Thus, AMM 102 acts as an intermediary for a device that needs to access application 104.

In step 207, AMM 102 sends the actionable message to one or more devices 106. The actionable message may be sent through any communication network. Also, AMM 102 may format the actionable message depending on the destination device. For example, an email may be formatted in a different way than an instant message. Also, the message may be formatted to different protocols the different destination devices 106 communicate in.

In step 208, AMM 102 receives a response to the actionable message from device 106. In one embodiment, the response includes the message identifier for the sent actionable message and an action identifier for a desired action. Although only one identifier is described as being received, it will be understood that multiple identifiers for multiple actions may be received in one response message.

In one embodiment, in addition to including the identifier for the actionable message and the identifier for a desired action, other parameters may also be included in the response message. For example, other parameters that may be used in performing the action may be included, such as account numbers, names, etc. Also, a service identifier that identifies a response message as a message for the actionable message service may be included. The service identifier may be used if AMM 102 handles other requests that may not be responses to an actionable message. For example, a response may include the content “actionable message<message identifier><action identifier>”. “Actionable message” is the service identifier and indicates that this message is a response to an actionable message. The service identifier may be omitted in some circumstances, such as when AMM 102 only processes responses to actionable messages. “<message identifier>” represents any identifier to a sent actionable message and “<action identifier>” represents any identifier for an action.

In step 210, AMM 102 determines the stored information using the message identifier received in the response message. In one embodiment, AMM 102 reviews the response message and determines what information in the response message corresponds to the message identifier. Also, information specific to a user or device 106 may be determined. For example, a user identifier or an address for the device 106 that sent the message is used with the message identifier to determine the stored information. AMM 102 then retrieves the stored information.

In step 212, AMM 102 determines an action in one or more actions using the identifier for the desired action and information in the stored information. For example, the identifier for the desired action in the response message is matched to an identifier in the stored information. Using the above example, if news is desired for a stock quote, a “1” is sent in the response message. AMM 102 then determines the action associated with the action identifier #1. The associated information may indicate that news for a stock should be retrieved. In one embodiment, the associated information may be a URL that retrieves news for the stock using application 104.

Accordingly, an identifier for the stored information and an identifier for the desired action in the response message are used to determine an action in the stored information. Accordingly, AMM 102 is an intermediary that uses information in the response message to determine information that is used to access application 104 for performing actions. Thus, the response message does not have to be compatible with application 104.

In step 214, the action is performed. In one embodiment, AMM 102 uses the stored information to determine how to perform the action. AMM 102 sends an instruction to cause application 104 to perform the desired action. For example, if a URL is associated with the action identifier, AMM 102 may make an HTTP request as specified by the URL to cause application 104 to perform an action. Actions that may be performed include printing a document, retrieving information, serving a web-page, etc. In one embodiment, the actions performed are web-based actions.

In step 216, the results of the performed action are sent to a device 106. In one embodiment, the result is sent to the device 106 that sent the response message. In another embodiment, the results may be sent to any other device 106. For example, email device 106-3 may send the response message but and the results may be sent to SMS device 106-1. Thus, a user may use a personal computer to send the response to the actual message and the results may be sent to a user's cellular phone through SMS.

In one embodiment, the response to the actual message is a plain text message. Also, in one embodiment, the information in the response is not compatible with application 104 by itself. For example, the identifiers found in the message do not invoke actions on application 104. Rather, the information in the response messages is used to access stored information to determine the action that is desired. The stored information is then used to perform the action with application 104.

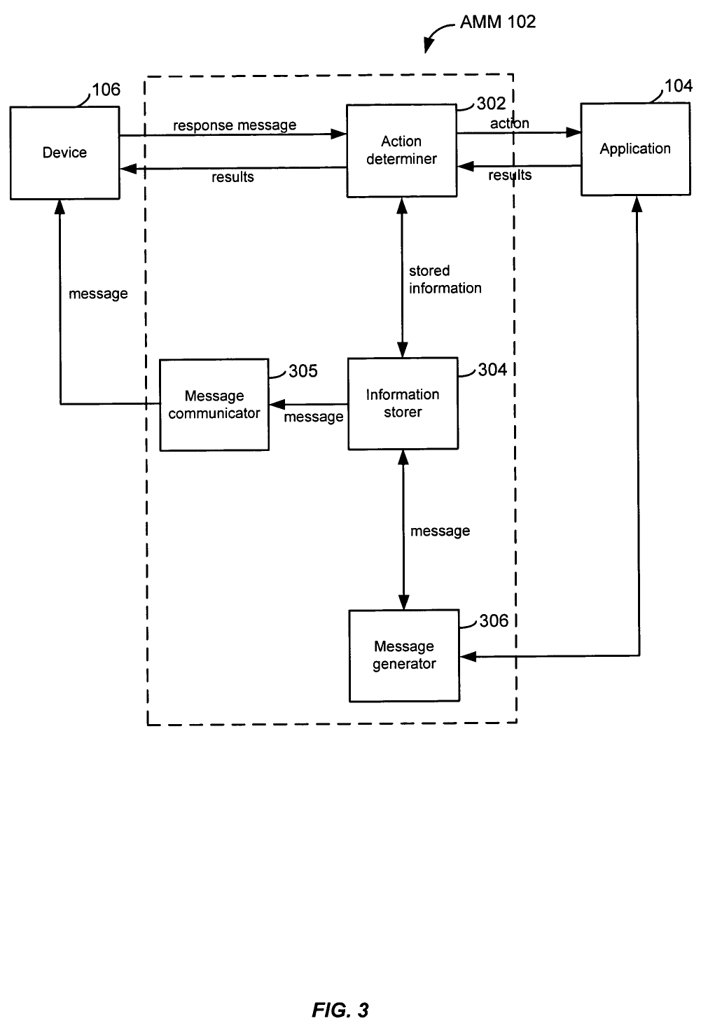

FIG. 3 illustrates a system 300 for providing actionable messages according to one embodiment of the present invention. System 300 includes device 106, actionable message manager 102, and application 104. AMM 102 includes an action determiner 302, an information storer 304, and a message generator 306.

Message generator 306 is configured to generate an actionable message. In one embodiment, message generator 306 generates a message by parsing web-based information. A program code may identify devices that the actionable message should be sent to and also actions that should be performed. For example, an XML document may be used to generate an actionable message. In one embodiment, the program code parses the XML document and determines actions that should be performed. For example, different tags in the XML document may indicate that an action should be performed. The program may generate a message for those actions. Accordingly, message generator 306 performs the functions described in steps 202 and 204 of FIG. 2.

Information storer 304 receives the actionable message and stores information for the actionable message. In one embodiment, information storer 304 may store a message identifier for the actionable message and one or more identifiers for one or more actions. Additionally, information storer 304 may store information usable in performing the one or more actions. The message identifier is used to uniquely identify the actionable message that is sent and is used to retrieve stored information corresponding to the actionable message. Accordingly, information storer 304 performs the functions described in step 206 of FIG. 2.

Message communicator 305 receives the generated message and sends the message to device 106. Message communicator 305 is configured to communicate with any device 106 and may format the message for a communication channel and protocol for a device. Accordingly, message communicator performs the functions described in step 207 of FIG. 2.

Device 106 receives the actionable message from message communicator 305 and sends a response message to AMM 102. When device 106 receives the actionable message, a user may determine a response message from information in the actionable message. In one embodiment, the response message includes a message identifier and an identifier for an action in one or more actions associated with the actionable message. The response message is then sent to AMM 102.

Action determiner 302 receives the response message from device 106 and is configured to determine an action to perform. Action determiner 302 determines the message identifier from the response message and uses the identifier to determine the stored information from information storer 304. The action identifier is then used to determine an action to perform from the stored information. Once the action to perform is determined, information on how to perform the action is determined from the stored information and the action is performed. Action determiner 302 communicates with application 104 to send a request for the action. Accordingly, action determiner 302 performs the functions described in steps 208, 210, 212, and 214 of FIG. 2.

Application 104 receives information for the action from action determiner 302 and performs the action. In one embodiment, the information for the action may be a web-based command that is interpreted by application 104 to perform the action. The result of the action is then generated by application 104. Accordingly, application 104 performs the functions described in step 214 of FIG. 2.

Action determiner 302 receives the result of the performed action from application 104 and sends the result to device 106. In one embodiment, action determiner 302 may send the result to any device 106 including devices other than the device 106 that sent the response message. Accordingly, action determiner 302 performs the functions described in step 216 of FIG. 2.

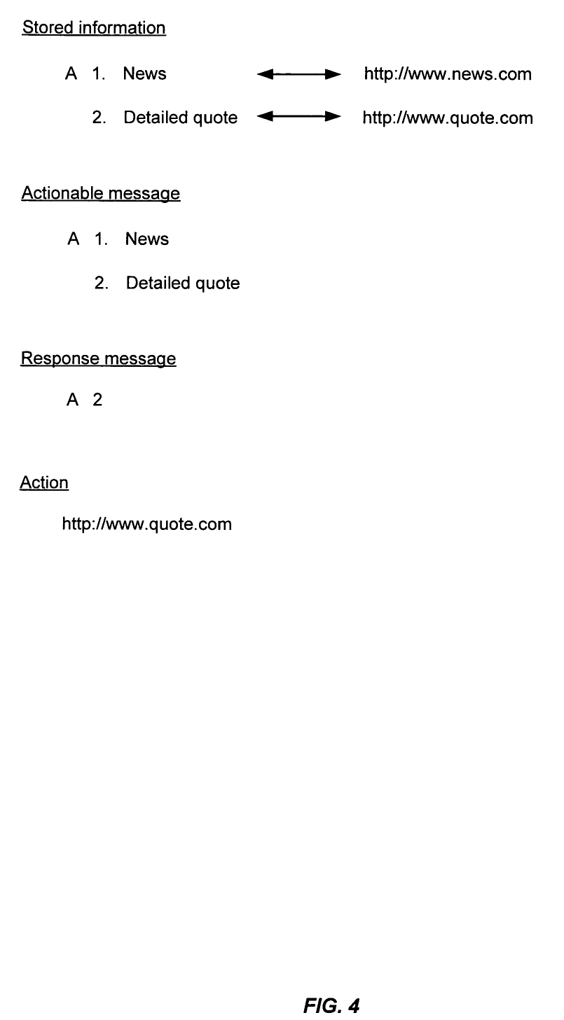

FIG. 4 illustrates an example of information included in stored information, an actionable message, a response message, and an action command. The stored information includes an message identifier of “A” and an identifier “1” that associates an action for retrieving news with a first action command (e.g., a first URL) and a second identifier “2” that associates an action for retrieved a detailed quote with a second action command (e.g., a second URL). The information found in the stored information may be used to perform an action with application 104.

The actionable message includes the message identifier, “A”, in addition to the first and second action identifiers, “1” and “2”. The message also includes a description of what actions the identifiers correspond to. In one embodiment, the actionable message does not include any URLs that are found in the stored information.

The response message includes the characters “A” and “2”. The letter “A” may be the message identifier and the number “2” may indicate that the second action of retrieving a detailed quote is desired. In one embodiment, information associated with the response message, such as a username or return address, is used in addition to the character A to determine the stored information. Accordingly, stored information for identifier “A” is retrieved and the identifier for the action is determined. In this case, the identifier “2” corresponds to the URL “http://www.quote.com” in the stored information.

The URL is invoked using application 104. Application 104 then performs the action specified by the URL. In one example, a detailed quote corresponding to the URL is retrieved. The detailed quote can then be sent back to the device that sent the response message or any other device.

Accordingly, embodiments of the present invention enable an actionable message to be sent to a device. The actionable message is initiated by AMM 102 and allows a user to respond to the message with a desired action. AMM 102 stores information related to the message in order to allow for it to determine an action to be performed when a response message is received from the device. When the response message is received, information in the response message is used to determine the stored information. An action is then determined using information in the response message and information in the stored information. The action is performed and the results are sent to the device.

Embodiments of the present invention include many advantages. For example, notification messages are turned to actionable messages that allow a user to perform actions. Thus, a user does not have to switch communication channels in order to perform a desired action when receiving an alert. For example, when a stock alert is sent to a user, actions such as retrieving a quote, retrieving news, and buying or selling the stock are enabled by responding to the message.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A method for messaging with devices in order to determine one or more actions to perform, the method comprising:
storing information for a message, the stored information comprising action information corresponding to the one or more actions;
sending a message to a device including a message identifier and one or more action identifiers corresponding to the one or more actions;
receiving a response message from the device, the response message including an action identifier in the one or more action identifiers and the message identifier;
determining the stored information using the message identifier;
determining action information for the action in the stored information using the action identifier; and
performing the determined action using the action information.

2. The method of claim 1, wherein the action information comprises information compatible with a web-based application, wherein the web-based application is used to perform the action.

3. The method of claim 1, wherein the sent message comprises a text-based message and the response message comprises a text-based message.

4. The method of claim 1, further comprising sending a result of the performed action to the device.

5. The method of claim 1, further comprising determining device information associated with the response message, wherein the message identifier and the device information are used to determine the stored information.

6. The method of claim 1, wherein the device information comprises at least one of information specific to a device and information specific to a user.

7. The method of claim 1, wherein the device comprises a mobile device.

8. A method for messaging with devices in order to determine one or more actions to perform, the method comprising:
storing information on how to perform one or more actions;
sending a message to a device including information identifying the one or more actions;
receiving a text message from the device including information identifying a desired action in the one or more actions;
determining stored information on how to perform the desired action using the information specifying the desired action; and
causing the determined action to be performed using the information on how to perform the desired action.

9. The method of claim 8, wherein the information on how to perform the one or more actions comprises web-based information.

10. The method of claim 9, wherein the web-based information comprises a URL.

11. The method of claim 8, wherein the sent message comprises a plain-text message.

12. The method of claim 8, wherein the text message comprises a plain-text message.

13. The method of claim 8, wherein determining the stored information comprises using a message identifier for the received message to determine the stored information.

14. The method of claim 8, further comprising sending a result of the performed action to the device.

15. A device for generating and processing messages to determine actions to perform, the device comprising:
a message generator configured to generate a message identifying one or more actions and to send the generated message to a device;
an information storer configured to store information associated with the identified one or more actions;
a receiver configured to receive a response message from the device, wherein the response message identifies an action in the one or more actions identified in the message sent to the device;
an action determiner configured to determine stored information for the identified action; and
an action performer configured to cause the action to be performed using the determined stored information.

16. The device of claim 15, wherein the generated message comprises a text message.

17. The device of claim 15, wherein the response message comprises a text message.

18. The device of claim 15, wherein the one or more actions comprise web-based actions.

19. The device of claim 15, wherein the action determiner determines the stored information using at least one of a message identifier for the response message to and information specific to the response message.

20. The device of claim 15, wherein the information specific to the response message comprises information specific to a user.

21. A system configured to perform actionable messaging, the system comprising:
one or more devices;
an application configured to perform actions; and
an actionable message device configured to communication with the one or more devices and the application, the device comprising:
a message generator configured to generate a message identifying one or more actions and to send the generated message to a device;
an information storer configured to store information associated with the identified one or more actions;
a receiver configured to receive a response message from the device, wherein the response message identifies an action in the one or more actions identified in the message sent to the device;
an action determiner configured to determine stored information for the identified action; and
an action performer configured to cause the action to be performed using the determined stored information.

22. The system of claim 21, wherein the one or more devices comprise mobile devices.

23. The system of claim 22, wherein the mobile devices are configured to receive messages exclusive of web-based messages.

24. The system of claim 22, wherein the mobile devices are configured to send messages exclusive of web-based messages.

25. The system of claim 21, wherein the application comprises a web-based application.
